(19) United States
(12) Patent Application Publication
(10) Pub. No.: US 2003/0008100 A1
(43) Pub. Date: Jan. 9, 2003

(54) Heat-insulating wall

(76) Inventor: Richard Horn, Herbrechtingen (DE)

Correspondence Address: LERNER AND GREENBERG, P.A., Post Office Box 2480, Hollywood, FL, 33022-2480, US

(21) Appl. No.: 10/160,945

(22) Filed: Jun. 3, 2002

Related U.S. Application Data
(63) Continuation of application No. PCT/EP00/10756, filed on Oct. 31, 2000.

(30) Foreign Application Priority Data
Dec. 1, 1999 (DE) 199 57 806.0

(51) Int. Cl. B32B 1/04

(52) U.S. Cl. 428/69; 428/137

(57) ABSTRACT

A thermally insulating wall based upon a vacuum insulation technique includes two outer layers and a cavity bridged by a duct to accommodate cables or similar devices. The duct is produced by ducting bodies with flange-like inserts and is created by a material deformation on at least one of the outer layers. The material deformation at least substantially reaches the other outer layer and is linked in a vacuum tight manner with the other layer. Alternatively, both outer layers can have the material deformation.

### CROSS-REFERENCE TO RELATED APPLICATIONS

This application is a continuation of copending International Application PCT/EP00/10756, filed Oct. 31, 2000 which designated the United States and which was not published in English.

### BACKGROUND OF THE INVENTION

Field of the Invention

The invention relates to a heat-insulating wall having two outer layers that are at a distance from one another, are at least substantially vacuum-tight, and are connected to one another in a vacuum-tight manner by a connecting profiled section so as to form a space that can be evacuated and filled with heat-insulation material. At least one lead-through for holding lines or the like, which opens out at the outer layers into apertures, is provided for the purpose of spanning the space.

In heat-insulating walls that are based on vacuum insulation technology, to produce lead-throughs at these walls the prior art uses separate lead-through bodies. To produce such a lead-through, these bodies are introduced into the space between the outer surfaces and, together with apertures that are formed in the outer surfaces, form a passage opening that spans the wall thickness of the heat-insulating wall for introduction of electrical or refrigeration lines or the like. To produce a vacuum-tight connection between the lead-through body and the outer surfaces using a reliable process, the lead-through body is provided at its end sides with flange-like projections, by which the lead-through body is connected in a vacuum-tight manner to the outer surfaces on the vacuum side. Although such a way of forming a lead-through achieves a high process reliability with regard to the vacuum-tightness at the interface between the lead-through body and the outer surfaces, a solution of this type not only means that an additional part is required for production of the lead-through, but also, at the same time, means that the manufacturing outlay, caused, in particular, by the positioning of the lead-through body with respect to the outer surfaces of the heat-insulating wall, is not inconsiderable. Furthermore, the dimensional demands imposed on the lead-through body mean that it was necessary for this body to be produced by material-removing machining processes, making production expensive.

### SUMMARY OF THE INVENTION

It is accordingly an object of the invention to provide, in a heat-insulating wall, a lead through that overcomes the hereinafore-mentioned disadvantages of the heretofore-known devices of this general type and that avoids the drawbacks of the prior art and employs simple measures for construction.

With the foregoing and other objects in view, there is provided, in accordance with the invention, a heat-insulating wall, including two substantially vacuum-tight outer layers disposed at a distance from one another and each being formed of a material, a connecting profiled section vacuum-tightly connecting the layers to one another to form an evacuable space therein, a heat-insulation material filling the evacuable space, at least one of the layers having a deformation in the material and defining a first aperture disposed at the deformation, the deformation substantially extending to and being vacuum-tightly connected to another of the layers, another of the layers defining a second aperture disposed opposite the first aperture, the deformation, the first aperture, and the second aperture forming at least one lead-through for receiving lines therethrough, the lead-through spanning at least part of the space and opening out at the layers.

According to the invention, the lead-through is at least as far as possible formed by a deformation in the material of one of the outer layers, which leads through the deformation in the material at least approximately to the other outer layer and is connected thereto in a vacuum-tight manner at least around the apertures.

The proposal according to the invention not only eliminates an additional component, with the result that manufacturing outlay is reduced, but also, at the same time, increases the process reliability with regard to the vacuum-tightness at the lead-through because additional process steps caused by the further joining points, which are fundamentally required according to the prior art, are avoided. The creation of the lead-through as a result of a corresponding deformation in the material at the outer surfaces also ensures that the homogeneity of material at the location of the lead-through at least substantially matches the homogeneity of material at the outer surfaces, whereas such a matching is not ensured according to the prior art because additional components are required. Within the context of producing the lead-through with the aid of a deformation in the material at the outer surfaces, it is simultaneously possible to carry out additional deforming or shaping operations involved in production of appliance-specific features that may be required, such as recesses for holding lines or the like, at low cost.

In accordance with another feature of the invention, the at least one of the layers is a first layer having a first deformation with a first end, the another of the layers is a second layer having a second deformation with a second end facing the first end, the first aperture is disposed in the first end, the second aperture is disposed in the second end, and the first end and the second end are vacuum-tightly connected to one another. Preferably, the lead-through is formed by a deformation in the material provided at both outer surfaces, which deformations are connected to one another in a vacuum-tight manner at their ends that face one another and are equipped with an aperture.

The deformation in the material that is carried out on both outer surfaces, on the one hand, considerably reduces the deformation force required to produce the deformation and, on the other hand, considerably reduces a weakening in the wall thickness that inevitably occurs during the deformation of the outer surfaces. Furthermore, the deformations in the material of the two outer surfaces, which deformations project into the evacuated space, make it easy to create the possibility of supporting these surfaces against one another and joining them to one another directly, in a vacuum-tight manner, at the location of the lead-through, in which case, if the outer surfaces are of stainless steel or corrosion-protected steel sheet, the welding by a beam-welding process is particularly favorably influenced by the homogeneity of material in the joining area. A particular benefit also results from the fact that the apertures in the outer surfaces can be introduced directly after the deformation of the surfaces, and, accordingly, in the same position on the machining tools and, therefore, with extremely high positional accuracy.

In accordance with a further feature of the invention, each of the deformations in the material formed on the two outer layers have a depth that is at least approximately half the width of the distance between the outer layers.

Not only does such a configuration reduce the deep-drawing forces, but also the thinning of the wall thickness caused by the deep-drawing is kept at a low level.

In accordance with an added feature of the invention, the material deformation is configured to be similar to a cup with a cup base that includes the aperture of the deformed outer layer and is connected in a vacuum-tight manner to the second outer layer.

Forming the deformation in the material to resemble a cup means that the cup base creates a planar support for the two outer surfaces at the lead-through point. As a result, a vacuum-tight connection between the two outer surfaces in the region around the lead-through point is achieved with extremely high process reliability and, at the same time, the fact that the cup bases of the outer surfaces bear against one another means that large-area supporting of the two outer surfaces against one another, which is able to resist deformation, is achieved.

In accordance with an additional feature of the invention, the first aperture and the second aperture are coaxially aligned.

With the objects of the invention in view, there is also provided a heat-insulating wall including two substantially vacuum-tight outer layers disposed at a distance from one another, a connecting profiled section vacuum-tightly connecting the layers to one another to form an evacuable space therein, a heat-insulation material filling the evacuable space, at least one of the layers having an integral deformed portion substantially extending to and being vacuum-tightly connected to another of the layers at a connection region, the deformed portion defining a first aperture at the connection region, another of the layers defining a second aperture at the connection region, and the deformed portion, the first aperture, and the second aperture forming at least one lead-through for receiving lines therethrough, the lead-through spanning at least part of the space and opening out at the layers.

With a view to introducing lead-throughs into heat-insulating walls that are based on vacuum insulation technology in household appliances, a refrigerator, a freezer, a dishwasher, a cooker, a washing machine or the like, having a heat-insulating wall, such as a heat-insulating housing, a heat-insulating door, a cooker muffle that is configured to be heat-insulating, a dishwashing compartment, or tub, is of a particularly advantageous configuration if, in accordance with a concomitant feature of the invention, the heat-insulating wall is a wall according to the invention.

Other features that are considered as characteristic for the invention are set forth in the appended claims.

Although the invention is illustrated and described herein as embodied in a heat-insulating wall, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, cross-sectional view of a first embodiment of a heat-insulating wall according to the invention having a cup-like deformation in material provided on one of its outer surfaces to produce a lead-through; and

FIG. 2 a fragmentary, cross-sectional view of a second variant of the heat-insulating wall according to the invention having a cup-like deformation in the material provided on both outer surfaces to produce a lead-through.

### DETAILED DESCRIPTION OF THE PREFERRED EMBODIMENTS

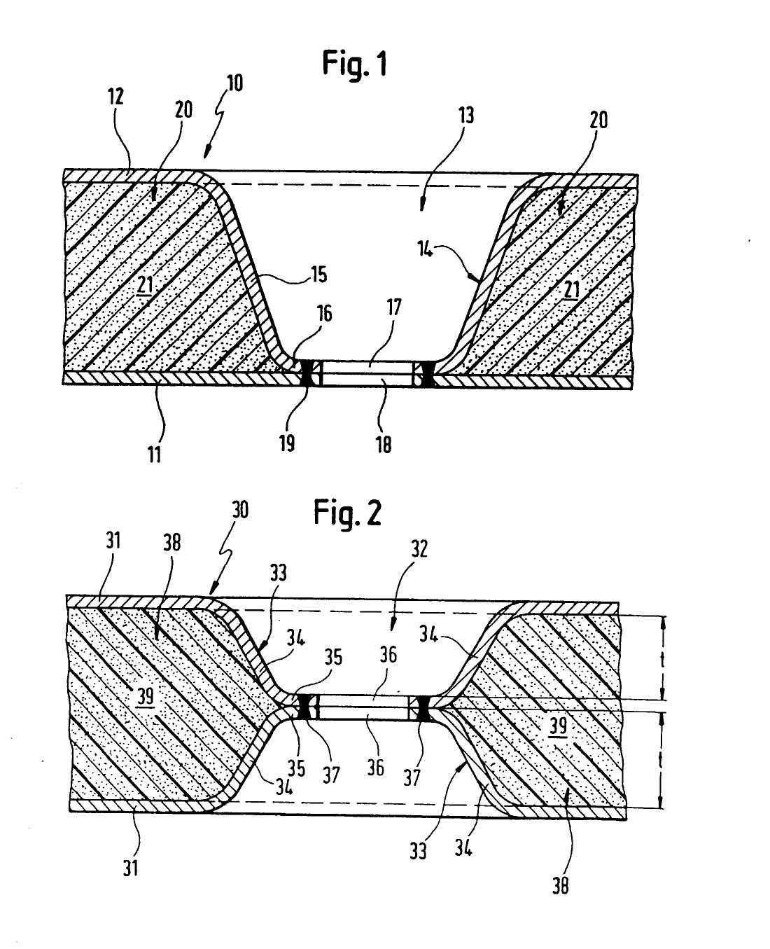

Referring now to the figures of the drawings in detail and first, particularly to FIG. 1 thereof, there is shown an excerpt of a simplified, diagrammatic illustration of a heat-insulting wall 10 that is based on vacuum insulation technology, is used, for example, to construct a refrigerator housing, a refrigerator door, a cooker muffle, a dishwasher tub, or the like, and has two outer layers 11 and 12 that are disposed at a distance from one another. The layers 11, 12 are formed, for example, from a stainless-steel plate or a corrosion-protected steel plate with a material thickness of approx. 0.4 mm or from a metal-coated or laminated plastic plate. Of the outer layers 11, 12, outer layer 12 has a deformation 14 in the material that is formed in the shape of a cup and is introduced into the outer layer 12 without the removal of material. The cup-shaped deformation 12 has a cup wall 15 and a cup base 16, which is at least as far as possible a planar configuration and has an aperture 17 to produce a lead-through 13, such as a line lead-through or an inlet or outlet opening. The outer side, which is remote from the cup compartment, of the cup base 16 runs all the way to the inner side, which is on the side of the vacuum insulation, of the outer layer 11, in order for the two outer layers 11 and 12 to be supported against one another. The outer layer 11, like the cup base 16, is provided with an aperture 18 that lies at least approximately congruently opposite the aperture 17 and, together with the latter and the cup-like depression 14 in the outer layer 12, forms the lead-through 13. To connect the outer layers 11 and 12 in a vacuum-tight manner in the region of the lead-through 13, there is a weld seam 19 that is disposed to run all the way around the contour of the apertures 17 and 18.

The outer layers 11, 12, which are at a distance from one another, together with a non-illustrated connecting profiled section disposed at free edges of the outer layers 11, 12, delimit a space 20 that can be evacuated and, in the evacuated state, is filled to the atmospheric pressure acting on the outer layers 11 and 12 with evacuable heat-insulation material 21 for supporting the outer layers 11, 12.

FIG. 2 is a simplified, diagrammatic illustration of a second variant of a heat-insulating wall 30 according to the invention based on vacuum insulation technology for use in a refrigerator housing, a refrigerator door, a cooker muffle, a dishwasher tub, or the like. The heat-insulating wall 30 has two outer layers 31 that are at a distance from one another and are formed, for example, from a stainless-steel plate or a corrosion-protected steel plate with a material thickness of 0.4 mm or from a metal-coated or laminated plastic plate. Each of the outer layers 31 is provided with a deformation 33 in its material, in the form of a cup, to create a lead-through 32 that is used, for example, as an inlet or outlet opening or as an opening for cables or the like. The cup-like material deformation 33 has a closed cup wall 34 and a cup base 35 that, at least as far as possible, is planar in configuration and into which an aperture 36 is introduced directly after the chipless indentation of the material deformation 33 in the outer layers 31, so that the apertures 36 in the cup bases 35 lie congruently opposite one another. The material deformations 33 in the outer layers 31 are directed toward one another, and their depths t are such that the outer sides, which face toward one another, of the cup base 35 take up half the distance between the outer layers 31 that are spaced apart from one another. The cup bases 35, which rest against one another, are joined to one another by a weld seam 37, which is disposed all the way around the lead-throughs 36 and that, together with the cup-like deformation 33 in the material, forms the lead-through 32 through the heat-insulating wall 30. At the free ends of the outer layers 31, the wall 30 has a non-illustrated connecting profiled section that is used to connect the outer layers 31 in a vacuum-tight manner and, together with the outer layers 31, encloses a space 38 that can be evacuated. To support the outer layers 31, in the evacuated state of the space 38 the space is filled to atmospheric pressure with evacuable heat-insulation material 39 that supports the two outer layers 31 with respect to one another.

In addition representing the heat-insulating wall according to the invention, both FIGS. 1 and 2 also represent a portion of a household appliance having the heat-insulating wall according to the invention. Example appliances include refrigerators, freezers, ovens, dishwashers, or the like.

I claim:

1. A heat-insulating wall, comprising:
two substantially vacuum-tight outer layers disposed at a distance from one another and each being formed of a material;
a connecting profiled section vacuum-tightly connecting said layers to one another to form an evacuable space therein;
a heat-insulation material filling said evacuable space;
at least one of said layers having a deformation in said material and defining a first aperture disposed at said deformation, said deformation substantially extending to and being vacuum-tightly connected to another of said layers;
another of said layers defining a second aperture disposed opposite said first aperture; and
said deformation, said first aperture, and said second aperture forming at least one lead-through for receiving lines therethrough, said lead-through spanning at least part of said space and opening out at said layers.

2. The heat-insulating wall according to claim 1, wherein:
said at least one of said layers is a first layer having a first deformation with a first end;
said another of said layers is a second layer having a second deformation with a second end facing said first end;
said first aperture is disposed in said first end;
said second aperture is disposed in said second end; and
said first end and said second end are vacuum-tightly connected to one another.

3. The heat-insulating wall according to claim 2, wherein:
said layers are separated from one another by a distance; and
each of said first and second deformations have a depth equal to approximately half of said distance.

4. The heat-insulating wall according to claim 2, wherein:
said first deformation is cup-shaped with a first cup base as said first end;
said first aperture is disposed in said first cup base;
said second deformation is cup-shaped with a second cup base as said second end;
said second aperture is disposed in said second cup base; and
said first cup base is vacuum-tightly connected to said second cup base.

5. The heat-insulating wall according to claim 1, wherein:
said deformation is cup-shaped and has a cup base including said first aperture; and
said cup base is vacuum-tightly connected to said another of said layers.

6. A household appliance, comprising:
a walled structure including at least one of a housing, a muffle, a door, and a tub;
said walled structure having at least one heat-insulating wall including:
two substantially vacuum-tight outer layers disposed at a distance from one another and each being formed of a material;
a connecting profiled section vacuum-tightly connecting said layers to one another to form an evacuable space therein;
a heat-insulation material filling said evacuable space;
at least one of said layers having a deformation in said material and defining a first aperture disposed at said deformation, said deformation substantially extending to and being vacuum-tightly connected to another of said layers;
another of said layers defining a second aperture disposed opposite said first aperture; and
said deformation, said first aperture, and said second aperture forming at least one lead-through for receiving lines therethrough, said lead-through spanning at least part of said space and opening out at said layers.

7. The heat-insulating wall according to claim 6, wherein the appliance is one of the group consisting of a refrigerator, a freezer, a dishwasher, an oven, and a washing machine.

8. A heat-insulating wall, comprising:
two substantially vacuum-tight outer layers disposed at a distance from one another;
a connecting profiled section vacuum-tightly connecting said layers to one another to form an evacuable space therein;
a heat-insulation material filling said evacuable space;
at least one of said layers having an integral deformed portion substantially extending to and being vacuum-tightly connected to another of said layers at a connection region;
said deformed portion defining a first aperture at said connection region;
another of said layers defining a second aperture at said connection region; and
said deformed portion, said first aperture, and said second aperture forming at least one lead-through for receiving lines therethrough, said lead-through spanning at least part of said space and opening out at said layers.

9. The heat-insulating wall according to claim 8, wherein said first aperture and said second aperture are coaxially aligned.

10. The heat-insulating wall according to claim 8, wherein:
said at least one of said layers is a first layer having a first deformed portion with a first end;
said another of said layers is a second layer having a second deformed portion with a second end facing said first end;
said first aperture is disposed in said first end;
said second aperture is disposed in said second end; and
said first end and said second end are vacuum-tightly connected to one another.

11. The heat-insulating wall according to claim 10, wherein:
said layers are separated from one another by a distance; and
each of said first and second deformed portions have a depth equal to approximately half of said distance.

12. The heat-insulating wall according to claim 10, wherein:
said first deformed portion is cup-shaped with a first cup base as said first end;
said first aperture is disposed in said first cup base;
said second deformed portion is cup-shaped with a second cup base as said second end;
said second aperture is disposed in said second cup base; and
said first cup base is vacuum-tightly connected to said second cup base.

13. The heat-insulating wall according to claim 8, wherein:
said deformed portion is cup-shaped and has a cup base including said first aperture; and
said cup base is vacuum-tightly connected to said another of said layers.

14. A household appliance, comprising:
a walled structure including at least one of a housing, a muffle, a door, and a tub;
said walled structure having at least one heat-insulating wall including:
two substantially vacuum-tight outer layers disposed at a distance from one another;
a connecting profiled section vacuum-tightly connecting said layers to one another to form an evacuable space therein;
a heat-insulation material filling said evacuable space;
at least one of said layers having an integral deformed portion substantially extending to and being vacuum-tightly connected to another of said layers at a connection region;
said deformed portion defining a first aperture at said connection region;
another of said layers defining a second aperture at said connection region; and
said deformed portion, said first aperture, and said second aperture forming at least one lead-through for receiving lines therethrough, said lead-through spanning at least part of said space and opening out at said layers.

15. The heat-insulating wall according to claim 14, wherein the appliance is one of the group consisting of a refrigerator, a freezer, a dishwasher, an oven, and a washing machine.
